(19) United States
(12) Patent Application Publication
(10) Pub. No.: US 2025/0287914 A1
(43) Pub. Date: Sep. 18, 2025

(54) WATER SUPPLY IN SLAUGHTERING SYSTEM

(71) Applicants: MAREL MEAT A/S, Roskilde (DK); MAREL ICELAND EHF., Gardabaer (IS)

(72) Inventors: Leif LYKKE, Roskilde (DK); Heinz MADSEN, Roskilde (DK); Karl SIGURJONSSON, Roskilde (DK); Patrick WESTERGAARD, Roskilde (DK)

(21) Appl. No.: 18/861,972

(22) PCT Filed: May 11, 2023
(86) PCT No.: PCT/EP2023/062564

§ 371 Date: Oct. 31, 2024

(30) Foreign Application Priority Data
May 12, 2022 (EP) 22173062.5

(51) Int. Cl. A01K 7/06; A01K 1/00; A61D 7/04

(52) U.S. Cl. CPC A01K 7/06; A01K 1/0035; A61D 7/04

(57) ABSTRACT

A slaughtering system includes a plurality of boxes, with each box configured to contain one or more slaughter animals; a box loading area for loading animals into the boxes, and a slaughtering facility including a lairage system comprising a lairage area for temporarily storing the animals before slaughter; an anesthetization section for anesthetizing the animals before slaughter. The boxes containing one or more animals are transported in and/or temporarily stored in at least portions of the slaughtering system. The slaughtering system includes one or more water supply mechanisms configured for supplying drinking water to boxes. The boxes and the water supply mechanisms are configured to couple to supply drinking water to animals, when contained in a box.

The present invention relates to a slaughtering system, wherein the animals to be slaughtered are moved and stored in boxes during at least part of the process before slaughtering.

### BACKGROUND OF THE INVENTION

In slaughtering facilities, such as slaughterhouses, legislation, at least in some countries, requires that a water supply is provided at least if the animals are kept over a predetermined period of time.

In slaughtering facilities, in particular slaughtering facilities configured for processing four-legged slaughter animals, such as hoofed animals, animals are often kept in pens in a lairage, for a period of time after they have been received at the slaughtering facility in order to rest the animals before processing.

Water is then supplied at the pens, when the animals are kept in pens in the lairage.

U.S. Pat. No. 7,717,773 discloses a system for stunning poultry, a stunning station is provided with a sprinkler to disperse droplets of water to preclude poultry from having a dry throat reaction.

In order to increase the welfare of the animals, in the entire system from the farm to where the animals are anaesthetised before slaughter, or at least at slaughtering facilities until the animals are anaesthetised, there is a need for providing drinking water to the animals.

### SUMMARY OF THE INVENTION

It has been realized that the welfare of slaughter animals may be improved if the animals are handled in boxes designed to contain one or more animals. Animals may be calmer when kept in boxes such as at slaughterhouses, relative to systems where the animals walk to the anaesthetization section/apparatus.

In one first aspect, the object of the invention is obtained by a slaughtering system comprising
a plurality of boxes, each box being configured to contain one or more slaughter animals;
a box loading area for loading animals into the boxes, and
a slaughtering facility comprising
   a lairage system comprising a lairage area for temporarily storing the animals before slaughter;
   an anesthetization section for anesthetizing the animals before slaughter;

wherein boxes containing one or more animals are transported in and/or temporarily stored in at least portions of the slaughtering system, and

wherein the slaughtering system comprises one or more water supply mechanisms configured for supplying drinking water to boxes, and wherein the boxes and the water supply mechanisms are configured to couple in order to supply drinking water to animals, when contained in a box.

The boxes forming part of the invention may be used
for transporting animals from a farm to a slaughter facility, and/or
for keeping the animals in lairage at the slaughter facility and/or
for transporting animals inside the slaughter facility for example between and/or into works station, such as the anesthetization section of the slaughter facility.

The slaughtering system according to the invention is particularly useful for slaughtering four-legged animals in particular hoofed animals.

For the purpose of this application by four-legged animals, in particular hoofed animals, is meant in particular porcine, bovine, caprine, and equines/equid animals.

Porcine animals are pigs/swine. Bovines comprise a diverse group of 10 genera of medium to large-sized ungulates, including domestic cattle, bison, African buffalo, water buffalos, and the four-horned and spiral-horned antelopes. Caprine animals are goats and sheep. Equines/equid animals are horses, donkeys, and zebras. Bovines and goats: bovidae (Latin). The bovidae comprises the biological family of cloven-hoofed, ruminant mammals that includes cattle, bison, buffalo, antelopes, and goat-antelopes. A member of this family is called a bovid.

In some embodiments, a box loading area may be located at the farm where the animals are raised, and one or more animals are loaded into each box at the box loading area, and transported to a slaughtering facility in the box. In such cases the transport, for example a truck, may be equipped with one or more water supply mechanisms for connecting to one or more boxes on the transport.

The boxes may be used to transport and store the animals all the way from the farm to and into the anesthetization section of a slaughtering facility. In yet other embodiments, the animals may be loaded into boxes at a box loading area provided at the slaughtering facility.

In any case the slaughtering system may be provided with one or more water supply mechanisms configured for supplying drinking water to boxes (and thereby to the animals) along any position from farm to the anesthetization section of a slaughtering facility.

In one embodiment, the slaughtering system comprises a first transport mechanism provided for transporting animals along a first transport path from the lairage area to the anesthetization section in boxes, wherein the first transport path comprises one or more water supply mechanisms configured for coupling with said boxes.

In this case the animals may be loaded into boxes at a box loading area located
at the farm,
at a receiving section for receiving animals to be slaughtered from transport, which receiving section forms part of the slaughtering facility, or
at the lairage of the slaughtering facility.

In a further embodiment thereof, a water supply mechanism is configured to move to a selected box located at a position or moving along said first transport path.

This may for example be obtained by robots comprising a drinking water tank, which robot may be configured to move along said first transport path, and further be configured to couple to a water inlet located on boxes of the slaughtering system.

Such a robot may be connected to an electronic location system providing information to the robot regarding the position of boxes, and the location on the boxes of the water inlet to which a water outlet of the robot is to be coupled. In other embodiment the position of the water inlet on a box may be located by a vision system.

Such a robot may be a wheeled robot capable of positioning itself adjacent to a box for providing water to the box. In other embodiments, the robot may be fixed at positions along the first transport path and comprising a robot arm carrying a water outlet, the arm being capable of reaching a water inlet of a box over a section of the first transport path.

In such embodiments, wherein a water supply mechanism is configured to move to a selected box located at a position or moving along said first transport path, the boxes (and thereby the animals) may be provided with drinking water either at positions along the first transport path, where a box is stopped, or the water may be provided to a box while in movement along the first transport path.

Alternatively or additionally, the first transport path comprises one or more box arrest stations arranged at positions along the first transport path, where a box may be stopped during transport, and wherein the box arrest stations are provided with a water supply mechanism configured for supplying drinking water to the animals contained in a box at the box arrest station.

In a simple embodiment thereof, water outlets connected for example to a common water supply of the slaughtering facility via a pipe system may be provided at each box arrest station, such that the water supply mechanism may be coupled to the box to provide drinking water thereto.

In an embodiment of the invention the slaughtering system may alternatively or additionally comprise one or more box arrest stations arranged adjacent to an inlet area to the anesthetization section, and wherein the one or more box arrest stations comprises a water supply mechanism configured for supplying drinking water to the animals contained in a box at the box arrest station.

Thereby, drinking water may be provided to animals in boxes that may be lined up at the inlet to the anesthetization section for example if the anesthetization process in the anesthetization section is delayed for some reason.

In a further embodiment the slaughtering system may further comprise
a relaxation section provided upstream of and adjacent to the anesthetization section, and where the relaxation section is configured for receiving the animals in boxes from the lairage area, and where the relaxation section is configured for calming the animals inside the boxes immediately before entering the anesthetization section, and
wherein the relaxation section comprises at least one box arrest station comprising a water supply mechanism configured for supplying drinking water to the animals contained in a box at the box arrest station.

In some embodiments, the first transport mechanism may be a vehicle, for example a forklift or a wheeled robot, which is configured for transporting said boxes.

However, in preferred embodiment each box arrest station may form part of or be connected to the first transport mechanism.

In an embodiment, the first transport mechanism is a conveyor.

In a further embodiment of any of the previously mentioned embodiments, the lairage area may be configured for storing the animals in boxes, and may comprise one or more water supply mechanisms configured for supplying drinking water to the boxes, and the boxes and the water supply mechanisms may be configured to couple to supply drinking water to animals, when the animals are contained in a box.

In this case the animals may have been loaded into boxes of the slaughtering system at a box loading area located
at the farm, or
at a receiving section for receiving animals to be slaughtered from transport, which receiving section forms part of the slaughtering facility.

In the former case, the receiving section may be configured for receiving animals from an externals source in boxes. In the latter case, the receiving section is configured for receiving animals in groups (from the transport from farm to slaughtering facility) and sorting the animals into boxes in sub-groups, suitable for being contained in a box. This may depend on the type of animal and the size of the box. In particular when the slaughtering animals are pigs, 1-15 pigs may be arranged in each box, such as 7-8 pigs, or 3-4 pigs.

In an embodiment, a water supply mechanism may be configured to move to and couple to a selected box located at a position in said lairage area, or for coupling to a box moving in said lairage area.

This may for example be obtained by one or more robots comprising or connecting to a drinking water tank, which robot may be configured to move in said lairage area, and further be configured to connect to a water inlet located on boxes of the slaughtering system.

Such a robot may be connected to an electronic location system providing information to the robot regarding the position of boxes in the lairage area, and the location on the boxes of the water inlet to which a water outlet of the robot is to be coupled. In other embodiments the position of the water inlet on a box may be located by a vision system.

Such a robot may be a wheeled robot capable of positioning itself adjacent to a box for providing water to the box. In other embodiments, the robot may be fixed at positions in the lairage and comprising a robot arm carrying a water outlet, the arm being capable of reaching a water inlet of a box over a section of a transport path in the lairage area, while the box is moved in the lairage area.

In such embodiments, wherein a water supply mechanism is configured to move and couple to a selected box located at a position or for coupling to a box moving in said lairage area, the boxes (and thereby the animals) may be provided with drinking water either at positions in the lairage area, where a box is stopped, or the water may be provided to a box while in movement in the lairage area.

Alternatively or additionally, in an embodiment, the lairage area may comprise a plurality of box arrest stations, where each box arrest station is configured for storing a box, and where at least a portion of the plurality of box arrest stations is configured with a water supply mechanism configured for supplying drinking water to the animals contained in a box at the box arrest station.

In an embodiment, the lairage system comprises a second transport mechanism for handling the boxes in the lairage area, such as a conveyor system.

Preferably, and in embodiments where the first transport mechanism in the first transport path is a conveyor, the second transport mechanism is connected to the conveyor of the first transport mechanism.

In an embodiment, each box arrest station in the lairage area forms part of or is connected to the second transport mechanism.

In some embodiments, where the slaughtering system comprises one or more box arrest stations, a box arrest station may comprise a platform for supporting a box.

In an embodiment thereof, a water supply mechanism may be connected to the platform.

In an embodiment thereof, the water supply mechanism may comprise a water supply pipe movable relative to the platform, and may be configured to couple with a box of the slaughtering system to supply drinking water into the box.

In an embodiment thereof, the water supply pipe may be arranged on an arm of the water supply mechanism, said arm being movably connected to the platform. This allows boxes to be inserted to and removed from the platform, when the arm has been moved away from a connected position. In one embodiment the arm is pivotally connected to the platform. In other embodiments the arm is configured for moving linearly relative to the platform in order to couple thereto to supply the drinking water.

In an embodiment, the water supply pipe comprises a distal end insertable into a box arrested on the platform. Thereby, drinking water may be supplied into the box, when the distal end is inserted in a box. The distal end may be provided with drinking nipple, so that animals contained in the box may drink from the nipple. Alternatively, water may be supplied to a drinking tank or to a trough from which the animals may drink.

In these embodiments the box may be provided with an opening through e.g. a sidewall, being located to cooperate with the distal end of the water supply mechanism.

Alternatively, in an embodiment, the water supply pipe comprises a distal end connectable to a tube connection provided in the box. Thereby, the box may be provided with cooperating means for receiving drinking water from of the water supply mechanism. The tube connection provided in the box may be provided with a drinking nipple, so that animals contained in the box may drink from the nipple. Alternatively, water may be supplied via the tube to a tank or to a trough from which the animals may drink.

In a further embodiment, at least a subset of the plurality of boxes of the slaughtering system are provided with a water holding tank from which drinking water may be provided to animals when in the boxes.

Such a water holding tank may be arranged in a bottom part of the box. In such embodiments the box may be provided with means configured for pressurizing the tank. Alternatively, such a water holding tank may be provided in a roof, or in a frame of the box. Alternatively, such a water holding tank may be provided inside an internal volume of the box.

In a second aspect of the invention, the objects of the invention may be achieved by a box for containing one or more live slaughter animals prior to slaughter, and for a slaughtering system according to any one of the above-mentioned embodiments of the first aspect of the invention.

Thus, the box is provided with means for connecting to a drinking water supply external of the box.

In an embodiment, the box comprises a pipe connection having a distal end extending into the box and a proximal end extending out of the box, where the distal end is provided with a drinking nipple or a trough, and the proximal end is provided with a connection means configured for connecting the pipe to an external drinking water supply.

In a further embodiment, the connection pipe is provided through a water supply opening through bars provided in a wall of the box.

In a further embodiment, the box comprises a water tank integrated in the box, and where the water tank is connectable to the drinking water supply external of the box, and is connected to a drinking nipple or a trough inside the box.

In a further embodiment, the water tank is provided above back height of the animal type for which the box is intended.

In a further embodiment, the drinking nipple is provided above back height of the animal type for which the box is intended.

In a further embodiment, the box is configured for containing one or more four-legged live slaughter animals, in particular hoofed animals.

It should be emphasized that the term “comprises/comprising/comprised of” when used in this specification is taken to specify the presence of stated features, integers, steps or components but does not preclude the presence or addition of one or more other features, integers, steps, components or groups thereof.

### BRIEF DESCRIPTION OF THE DRAWINGS

In the following, the invention will be described in greater detail with reference to embodiments shown by the enclosed figures. It should be emphasized that the embodiments shown are used for example purposes only and should not be used to limit the scope of the invention.

FIG. 1, in diagram form, illustrates an embodiment of a slaughtering system according to an embodiment of the invention, wherein animals are loaded into boxes at a farm, and kept in a box throughout the slaughtering system i.e. until the animals are anaesthetized, the slaughtering system comprising water supply mechanisms at a plurality of locations in the slaughtering system;

FIG. 2, in a perspective view, shows a box according to an aspect of the invention located on a platform of a box arrest station comprising a drinking water supply coupled to a pipe connection of the box; and

FIG. 3 shows details of an opening into a box for inserting a portion of a drinking water supply according to on embodiment of the invention.

### DETAILED DESCRIPTION OF THE EMBODIMENTS

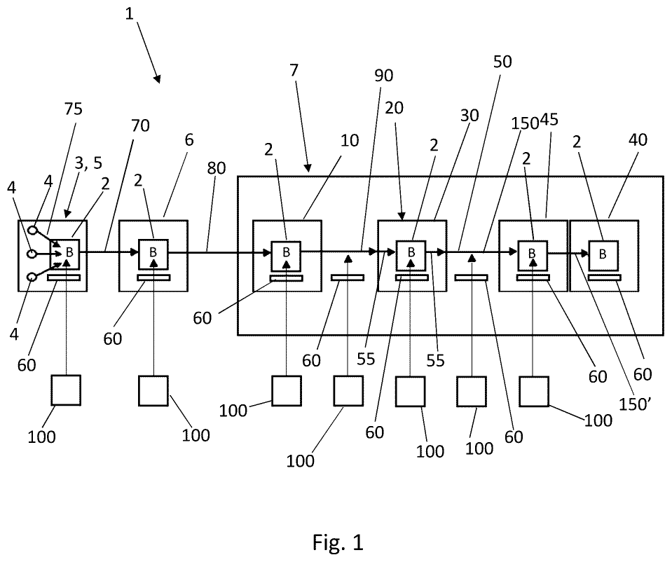

FIG. 1 discloses an embodiment of a slaughtering system 1 according to the invention

Generally, the slaughtering system 1 comprises
a plurality of boxes 2;
a box loading area 5 for loading animals into the boxes 2, and
a slaughtering facility 7

The box loading area 5 may also be called a box loading station 5.

Each box 2 of the slaughtering system 1 is configured to contain one or more slaughter animals 4, loaded into the box at the box loading station 5. In FIG. 1 the boxes of the slaughtering system 1 are designated with a B. In the following, the slaughter animals will be referred to simply as animals for the sake of simplicity. The slaughtering system 1 according to the invention is particularly useful for handling slaughter animals such as four-legged animals, in particular hoofed animals.

In the general case the slaughtering facility 7 comprises
a lairage system 20 comprising a lairage area 30 for temporarily storing the animals 4; and
an anesthetization section 40.

The anesthetization section 40 is configured for anesthetizing the animals before slaughter.

The lairage area 30 is configured for temporarily storing the animals 4, such that they may rest after being received from transport from e.g. a farm 3 at a receiving section 10 of the slaughtering facility 7.

The boxes 2 forming part of the slaughtering system 1 may be used
for transporting animals 4 from a farm to a slaughter facility 7, and/or
for keeping the animals in the lairage area 30 at the slaughtering facility 7 and/or
for transporting animals 4 inside the slaughtering facility 7 for example between and/or into works station of the slaughtering facility 7, such as the anesthetization section 40.

In some embodiments, and as shown in FIG. 1, the box loading area 5 may be located at the farm 3 where the animals 4 have been raised, and the boxes 2 may be used to transport and store the animals all the way from the farm 3 to and into the anesthetization section 40 of a slaughtering facility 7, as shown in FIG. 1, showing the path of a box 2 though the entire slaughtering system 1 according to one embodiment of the invention.

In other embodiments, the animals 4 may be reloaded along this way or path. In yet other embodiments, the animals 4 may be loaded into boxes 2 at a box loading area/box loading station provided in the slaughtering facility 7.

As indicated in FIG. 1, one or more animals 4 may be loaded into a box 2 at the box loading area 5, as indicated by arrows 75 in FIG. 1. Then, the box 2 containing the one or more animals is loaded onto a transport 6 as indicated by arrow 70, and transported to the slaughtering facility 7, as indicated by arrow 80 in FIG. 1. The transport 6, may for example be truck. Normally, several such boxes 2 will be transported to the slaughtering facility 7 simultaneously by a transport 6.

As indicated in FIG. 1, when arriving at the slaughtering facility 7, the box 2 containing the one or more animals 4 is unloaded into the receiving section 10 of slaughtering facility 7.

From the receiving section 10, the box 2 containing the one or more animals 4 is transferred to a lairage area 30 of the of a lairage system 20, as indicated by the arrow 90.

In the embodiment shown in FIG. 1, the lairage area 30 is configured for storing the animals in boxes 2. It will be understood that the lairage area 30 is configured for storing a plurality of boxes 2, each containing one or more animals 4.

After resting in the lairage area 30, preferably at least long enough for the animals to calm, if they have been exited or stressed by the transport 80 and reloaded at the receiving section 10, the box 2 containing the one or more animals 4 is transported to a relaxation section 45 along a first transport path 150.

The relaxation section 45 is optional. Further, the relaxation section 45 may be provided upstream of and adjacent to the anesthetization section 40, such that the boxes 2 containing one or more animals 4 will pass through the relaxation section 45 immediately before entering the anesthetization section 40.

The relaxation section 45 is configured for receiving the animals in boxes from the lairage area 30.

Further, the relaxation section 45 is configured for calming the animals inside the boxes 2 immediately before entering the anesthetization section 40. Calming the animals in the relaxation section 45 may comprises the use of one or more of the following:
light in wavelengths known to calm the animals;
sounds known to calm the animals, such as pan pipe music
providing an atmosphere with reduced oxygen and/or increased CO2 level not resulting in the animals being anaesthetized.

Other measures may be used in addition hereto.

After passing through the relaxation section 45, the box 2 containing the one or more animals 4, is transported into the anesthetization section 40 via a last section 150′ of the first transport path 150.

In the anesthetization section 40 the animals 4 contained in the box 2 are anesthetized, for example by use of an atmosphere having an increased CO₂ content.

When all the animals in a box 2 have been anesthetized, in the anesthetization section 40, the box is removed therefrom (not shown), and the animals are taken out of the box 2, for slaughter i.e. sticking, bleeding, etc.

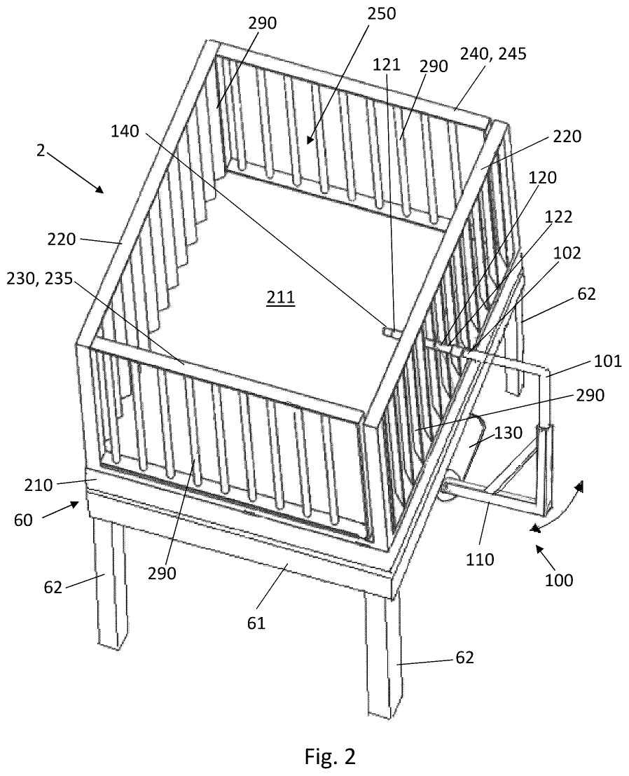

According to the invention, the slaughtering system 1 comprises one or more water supply mechanisms 100 configured for supplying drinking water to boxes 2, such as the box shown in FIG. 2. Further, the boxes 2 and the water supply mechanisms 100 are configured to couple in order to supply drinking water to animals, when contained in a box.

Such water supply mechanisms 100 may be arranged along the entire way through the slaughtering system 1 up till anaesthetization, as indicated in FIG. 1. The slaughtering system 1 according to various embodiments of the invention may be provided with one or more water supply mechanisms 100 provided at the locations indicated in FIG. 1, and as described in further details in the following.

In any case the slaughtering system 1 may be provided with one or more water supply mechanisms 100 configured for supplying drinking water into boxes 2 (and thereby to the animals) along any position from farm 3 to the anesthetization section 40 of a slaughtering facility 1.

In one embodiment where one or more animals are loaded into a box 2 at a box loading station 5 provided at the farm 3, as shown in FIG. 1, the transport 6, for example a truck, may be equipped with one or more water supply mechanisms 100 for connecting to one or more boxes on the transport 6.

In principle, and as shown in FIG. 1, a water supply mechanism 100 may be located at the box loading station 5 at the farm 3.

As also indicated in FIG. 1 one or more water supply mechanisms 100 may be provided at the receiving section 10 of the slaughtering facility 7.

Further, as shown in FIG. 1, one or more water supply mechanisms 100 may be provided in a path 90 from the receiving section 10 of the slaughtering facility 7 to the lairage area 30, in embodiments where animals are transported from the receiving section to the lairage area 30 in boxes 2. This is the case, when the animals are loaded into boxes at a box loading area 5 at the farm 3, as shown in FIG. 1, or in (not shown) embodiments, where animals 4 are loaded into boxes 2 at a box loading area 5 provided at the receiving section 10 of the slaughtering facility 7.

Further, as shown in FIG. 1, one or more water supply mechanisms 100 may be provided in the lairage area 30 of the slaughtering facility 7.

Further, as shown in FIG. 1, one or more water supply mechanisms 100 may be provided in the first transport path 150 between the lairage area 30 of the slaughtering facility 7 and the anesthetization section 40, or in the first transport path 150 between the lairage area 30 and the relaxation section 45 in embodiments, where the slaughtering system 1 comprises such a relaxation section 45 upstream of the anesthetization section 40.

In embodiments, where the slaughtering system 1 comprises such a relaxation section 45 upstream of the anesthetization section 40 as shown in FIG. 1, one or more water supply mechanisms 100 may be provided in the relaxation section 45.

It will be understood that the slaughtering system 1 according to various embodiments, may comprise water supply mechanisms 100 at any or all of the above-mentioned locations. In FIG. 1 it is shown that the slaughtering system 1 may further comprise a box arrest station 60 at each of the locations provided with water supply mechanism(s) 100, which box arrest stations 60 will be described in detail further below. However, the water supply mechanism(s) 100 may supply water to boxes in other ways, not utilizing these box arrest stations 60. Such embodiments will also be described below.

In one embodiment, the slaughtering system 1 comprises a first transport mechanism 50 provided for transporting animals along the first transport path 150 from the lairage area 30 to the anesthetization section 40 in boxes, wherein the first transport path 150 comprises one or more water supply mechanisms 100 configured for coupling with the boxes 2.

In this embodiment, the animals may have been loaded into boxes 2 at a box loading area 5 located at either
at the farm 3,
at the receiving section 10, or
at the lairage area 30 of the slaughtering facility.

In one embodiment thereof, the water supply mechanism(s) 100 is/are configured to move to a selected box located at a position along said first transport path 150, or for moving along said first transport path 150 together with a box 2 as it moves along the first transport path 150.

This may for example be obtained by one or more robots (not shown) comprising a drinking water tank or which is connected to a supply of drinking water, which robot may be configured to move along at least a portion of the first transport path 150, and further be configured to couple to a water inlet located on boxes 2 of the slaughtering system 1.

Such a robot may be a wheeled robot (not shown) capable of positioning itself adjacent to a box 2 for providing water to the box 2. In other embodiments, a robot may be fixed at each of one or more positions along the first transport path 150 and comprise a robot arm carrying a water outlet, the arm being capable of reaching a water inlet of a box 2 over a section/portion of the first transport path 150.

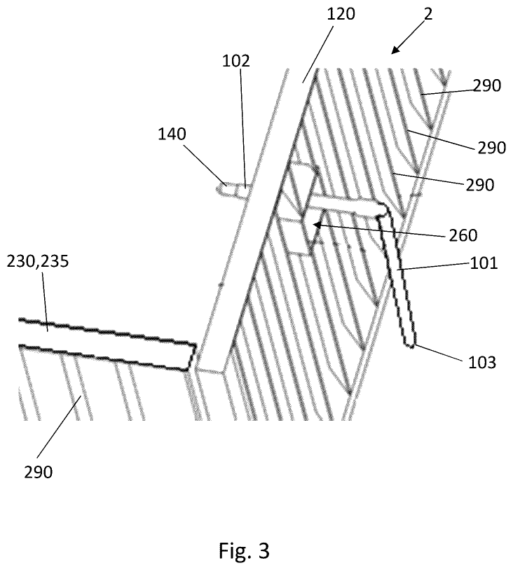

Alternatively or additionally, the first transport path 150 may comprise one or more box arrest stations 60, as mentioned above. These box arrest stations 60 may be arranged at positions along the first transport path 150. A box 2 passing by during transport may be stopped at a box arrest station 60 for providing water into the box in one of the ways discussed below in connection with FIGS. 2 and 3.

Preferably, the box arrest stations are provided with a water supply mechanism 100 configured for supplying drinking water to the animals contained in a box 2, when located at the box arrest station 60.

For example, this may be provided in a simple embodiment by water outlets of the water supply mechanism 100 being connected to a common water supply (not shown) of the slaughtering facility 7 via a pipe system (not shown), such that the water supply mechanism 100 may be coupled to the box 2 to provide drinking water thereto.

In a further embodiment the slaughtering system 1 may alternatively or additionally comprise a relaxation section 45, as briefly described above. The relaxation section may comprise at least one box arrest station 60. The box arrest station 60 may comprise a water supply mechanism 100 configured for supplying drinking water to the animals contained in a box 2, when a box 2 is at the box arrest station 60 in the relaxation section 45.

The above-mentioned first transport mechanism 50 may in some embodiments be a vehicle, for example a fork lift or a wheeled robot, which is configured for transporting said boxes 2. Such a vehicle may then stop at a box arrest station to provide drinking water into the box 2. However, in other embodiments each box arrest station 60 may form part of or be connected to the first transport mechanism, for example a conveyor provided to transport boxes along the first transport path.

In a further embodiment of any of the previously mentioned embodiments, the lairage area 30 may be configured for storing the animals in boxes 2. In this case the animals 4 may have been loaded into the boxes 2 of the slaughtering system 1 at a box loading area 5 located
at the farm 3, as shown in FIG. 1, or
at the receiving section 10.

In these embodiments, the lairage area 30, comprises water supply mechanisms 100 configured for supplying drinking water to the boxes 2, and the boxes 2 and the water supply mechanisms 100 are configured to couple to supply drinking water to animals, when the animals are contained in a box.

This may be accomplished in various ways. In one embodiment, a water supply mechanism 100 may be configured to move to and couple to a selected box 2 located at a position in said lairage area 30, or for coupling to a box 2 moving in said lairage area 30. Alternatively or additionally, in an embodiment, the lairage area 30 may comprise a plurality of box arrest stations 60, where each box arrest station 60 is configured for storing a box 2, and where at least a portion of the plurality of box arrest stations 60 is configured with a water supply mechanism 100 configured for supplying drinking water to the animals 4 contained in a box 2, when at the box arrest station 60.

The embodiments where the water supply mechanism 100 is configured to move, may for example be obtained by one or more robots (not shown) comprising or connecting to a drinking water tank, which robot may be configured to move in said lairage area 30, and further be configured to connect to a water inlet located on boxes 2 of the slaughtering system 1.

Such a robot may be a wheeled robot (not shown) capable of positioning itself adjacent to a box 2 for providing water to the box 2. In other embodiments (not shown), one or more robots may be fixed at positions in the lairage area 30. Each of the one or more robots, may in this case comprise a robot arm carrying a water outlet, the arm being capable of reaching a water inlet of a box 2 over a section of a transport path in the lairage area 30, while the box 2 is moved in the lairage area 30.

In an embodiment, the lairage system 20 may comprise a second transport mechanism 55 for handling the boxes in the lairage area 30, such as a conveyor system.

Preferably, and in embodiments where the first transport mechanism 50 in the first transport path 150 is a conveyor, the second transport mechanism 55, preferably in the form of a conveyor, is connected to the conveyor of the first transport mechanism 50. Further, each box arrest station 60 in the lairage area 30, in the embodiments comprising such box arrest stations 60, may form part of or being connected to the second transport mechanism 55, e.g. a conveyor.

Turning now to FIG. 2, first the boxes 2 which may be used in the slaughtering system 1 are described in more detail. FIG. 2 shows an embodiment of such a box 2, the box comprising a squared, here a rectangular bottom part 210, an inlet 230 comprising an inlet gate 235, an end wall 240 which may comprise an end wall gate 245, and two sidewalls 220. The bottom part 210 comprises an upwardly facing surface 211. The bottom part 210, the sidewalls 220, the inlet and the end wall 240 defines an internal volume 250 between them. In not shown embodiments, the box 2 may further comprise a roof (not shown). Any of the sidewalls 220, the inlet gate 235 and the end wall 240/end wall gate 245 may comprise bars, e.g. vertically arranged and spaces apart bars 290 to increase ventilation of the box 2.

A lower surface (not shown) of the bottom part 210 of the box 2 may preferably be configured for cooperating with e.g. a box arrest station 60, and with a mechanism for moving the box, e.g. a conveyor, such as the conveyer of the first transport mechanism 50 and the second transport mechanism 55, described above.

In FIG. 2, the box 2 shown is seen located on a platform 61, which platform 61 forms a part of a box arrest station 60, e.g. as described above. The box arrest station may further comprise (not shown) conveying means for moving the box 2 onto or away from the platform 61 of the box arrest station 60. The box arrest station 60 may form a link in a conveyor forming part of the above-mentioned first transport mechanism 50 provided between the lairage area 30 and the anaesthetization section 40. Alternatively of additionally, a box arrest station 60 as shown in FIG. 2 may form a link in a conveyor forming part of the above mentioned second transport mechanism 55 provided in the lairage area 30.

The box arrest station 60 further comprises an embodiment of the water supply mechanism 100. The water supply mechanism 100 shown comprises a water supply pipe 101. The water supply pipe 101 has a distal end 102, which may be coupled to a proximal end 122 of a pipe connection 120 provided on the box 2, and extending through a sidewall 220 of the box 2.

The pipe connection 120 provided on the box 2 comprises a distal end, extending into the box 2 and a proximal end extending out of the box 2. The proximal end 122 of the pipe connection 120 is configured for coupling to distal end 102 of the supply pipe 101.

The water supply mechanism 100 shown may further comprise an arm 110, which arm 110 is configured for moving the distal end 102 of the supply pipe 101 of the water supply mechanism 100 towards and away from the proximal end 122 of the pipe connection 120 in order to couple to or decouple from the proximal end 122 of the pipe connection 120. In the embodiment shown in FIG. 2, this may be provided by the arm 110 being connected to an actuator 130. The actuator 130 is connected to the platform 61 of the box arrest station 60. The actuator 130 is configured for swinging or pivoting the arm 110 of the water supply mechanism 100, to couple or decouple the distal end 102 of the supply pipe 101 and the proximal end 122 of the pipe connection 120.

Thereby the supply pipe 101 may be made movable relative to the platform 61, and may be configured to couple with a box of the slaughtering system to supply drinking water into the box.

By making the arm 110 of the water supply mechanism 100 movably connected to the platform 61 it is further achieved that boxes 2 may be inserted to and removed from the platform 62, when the arm 110 has been moved away from a coupled position.

In the embodiment described in connection with FIG. 2, the arm 110 is pivotally connected to the platform 61. It will however be understood that in other embodiments (not shown), the arm 110 may alternatively be configured for moving linearly or in any other way relative to the platform 61 in order to couple thereto to supply the drinking water.

The distal end 121 of the pipe connection 120 provided in the box 2, may be provided with a drinking nipple 140 from which animals 4 contained in a box 2 may drink. However, in other embodiments, the distal end 121 of the pipe connection 120 may instead be arranged to fill a trough arranged in the box, and from which the animals 4 may drink. In yet other alternative embodiments (not shown) the distal end 121 of the pipe connection 120 may connect to a water holding tank provided in the box, see below.

Legs 62 may be connected to the platform 61 of the box arrest station 60.

Now turning to FIG. 3 showing an embodiment, where the water supply pipe 101 of the water supply mechanism 100 comprises a distal end 102 insertable into a box 2, when the box is arrested on the platform 61 of a box arrest station 60. Thereby, drinking water may be supplied into the box 2 when the distal end 102 of the water supply pipe 101 is inserted in a box. The distal end may be provided with drinking nipple 140, so that animals contained in the box 2 may drink from the drinking nipple 140. Alternatively, water may be supplied to a drinking tank (not shown), or to a trough (not shown) provided in the box 2, and from which the animals may drink.

In these embodiments the box 2 may be provided with an opening 260 through a wall e.g. a sidewall 220 of the box 2. The opening through the wall is located to cooperate with the distal 102 end of the water supply mechanism 100.

In the latter embodiments, the water supply pipe 101 of the water supply mechanism 100 may be movable relative to the platform 61 in the same way as described in connection with FIG. 2.

In a further embodiment, at least a subset of the plurality of boxes 2 of the slaughtering system 1 are provided with a water holding tank (not shown) from which drinking water may be provided to animals 4 when in the boxes 2.

Such a water holding tank may be arranged in a bottom part of the box. Alternatively, such a water holding tank may be provided in a frame of the box. Alternatively, such a water holding tank may be provided inside an internal volume of the box.

It is to be noted that the figures and the above description have shown the example embodiments in a simple and schematic manner. Many of the specific mechanical details have not been shown since the person skilled in the art should be familiar with these details and they would just unnecessarily complicate this description.

1.-30. (canceled)

31. A slaughtering system comprising:
a plurality of boxes, each box being configured to contain one or more slaughter animals;
a box loading area for loading animals into the boxes, and
a slaughtering facility comprising
a lairage system comprising a lairage area for temporarily storing the animals before slaughter;
an anesthetization section for anesthetizing the animals before slaughter;
wherein boxes containing one or more animals are transported in and/or temporarily stored in at least portions of the slaughtering system, and
wherein the slaughtering system comprises one or more water supply mechanisms configured for supplying drinking water to boxes, and
wherein the boxes and the water supply mechanisms are configured to couple in order to supply drinking water to animals, when contained in a box.

32. The slaughtering system according to claim 31, comprising
a first transport mechanism provided for transporting animals along a first transport path from the lairage area to the anesthetization section in boxes,
wherein the first transport path comprises one or more water supply mechanisms configured for coupling with said boxes.

33. The slaughtering system according to claim 32, wherein a water supply mechanisms is configured to move to a selected box located at a position or moving along said first transport path.

34. The slaughtering system according to claim 32, wherein the first transport path comprises one or more box arrest stations arranged at positions along the first transport path, where a box may be stopped during transport, and
wherein the box arrest stations are provided with a water supply mechanism configured for supplying drinking water to the animals contained in a box at the box arrest station.

35. The slaughtering system according to claim 31, comprising one or more box arrest stations arranged adjacent to an inlet to the anesthetization section, and
wherein the one or more box arrest stations comprises a water supply mechanism configured for supplying drinking water to the animals contained in a box at the box arrest station.

36. The slaughtering system according to claim 31,
wherein a relaxation section is provided upstream of and adjacent to the anesthetization section,
wherein the relaxation section is configured for receiving the animals in boxes from the lairage are,
wherein the relaxation section is configured for calming the animals inside the boxes immediately before entering the anesthetization section, and
wherein the relaxation section comprises at least one box arrest station comprising a water supply mechanism configured for supplying drinking water to the animals contained in a box at the box arrest station.

37. The slaughtering system according to claim 34, wherein each box arrest station forms part of or is connected to the first transport mechanism.

38. The slaughtering system according to claim 31, wherein the lairage area is configured for storing the animals in boxes,
wherein the lairage area comprises a water supply mechanism configured for supplying drinking water to boxes, and
wherein the boxes and the water supply mechanisms are configured to couple to supply drinking water to animals, when contained in a box.

39. The slaughtering system according to claim 38, wherein at least one water supply mechanism is configured to move to a selected box located at a position in said lairage area and couple thereto, or for coupling to a box moving in said lairage area.

40. The slaughtering system according to claim 38, wherein the lairage area comprising a plurality of box arrest stations,
wherein each box arrest station is configured for storing a box, and
wherein at least a portion of the plurality of box arrest stations is configured with a water supply mechanism configured for supplying drinking water to the animals contained in a box at the box arrest station.

41. The slaughtering system according to claim 38, wherein the lairage system comprises a second transport mechanism for handling the boxes in the lairage area.

42. The slaughtering system according to claim 34, wherein a box arrest station comprises a platform for supporting a box.

43. The slaughtering system according to claim 42, wherein a water supply mechanism is connected to the platform.

44. The slaughtering system according to claim 43, wherein the water supply mechanism comprises a water supply pipe movable relative to the platform and configured to couple with a box of the slaughtering system to supply drinking water into the box.

45. The slaughtering system according to claim 44, wherein the water supply pipe is arranged on an arm of the water supply mechanism, said arm being moveably connected to the platform.

46. The slaughtering system according to claim 45, wherein the water supply pipe comprises a distal end insertable into a box when the box arrested on the platform.

47. The slaughtering system according to claim 46 wherein the water supply pipe comprises a distal end connectable to a tube connection provided in the box.

48. A box for containing one or more live slaughter animals prior to slaughter and for a slaughtering system according to claim 31,
wherein the box is provided with means for connecting to a drinking water supply external of the box.

49. The box according to claim 48, wherein the box comprises a pipe connection having a distal end extending into the box and a proximal end extending out of the box, where the distal end is provided with a drinking nipple, and the proximal end is provided with a connection means configured for connecting the pipe to an external drinking water supply.

50. The box according to claim 49, wherein the box comprises a water tank integrated in the box, and where the water tank is connectable to the drinking water supply external of the box, and is connected to a drinking nipple inside the box.
